(19) United States
(12) Patent Application Publication
(10) Pub. No.: US 2002/0012095 A1
(43) Pub. Date: Jan. 31, 2002

(54) LIQUID CRYSTAL DISPLAY HAVING HIGH CONTRAST RATIO

(76) Inventors: CHANG-HOON LEE, KYUNGKI-DO (KR); JUNG-UK SHIM, KYUNGKI-DO (KR); KYEONG-HYEON KIM, KYUNGKI-DO (KR)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 09/223,274

(22) Filed: Dec. 30, 1998

(30) Foreign Application Priority Data
Dec. 31, 1997 (KR) 97-80199

(51) Int. Cl. G02F 1/1339

(52) U.S. Cl. 349/155

(57) ABSTRACT

Alignment of the liquid crystal molecules near the spacers is controlled by using spacers which align the liquid crystal molecules parallel or perpendicular to the surfaces of the spacers. Light leakage near the spacers due to a disordered alignment of the liquid crystal molecules is reduced, thereby decreasing the luminance in black state. As a result, the contrast ratio is increased.

### BACKGROUND OF THE INVENTION

(a) Field of the Invention

The present invention relates to a liquid crystal display having high contrast ratio.

(b) Description of the Related Art

A liquid crystal display (LCD) includes two substrates and a liquid crystal layer interposed therebetween. The transmittance of light is controlled by the intensity of the electric field applied to the liquid crystal layer of the LCD.

Some of the significant properties of an LCD, such as response time, contrast ratio and viewing angle are directly related to the cell gap, or the thickness of the liquid crystal layer.

Spacers are conventionally used for controlling and maintaining the cell gap of the LCD. The spacers are typically made of plastics, having elasticity such that the size of the spacers may vary according to the weight applied thereto. Accordingly, it is difficult to maintain a uniform cell gap using the plastic spacers. As a result, silica beads have become more popular as spacers since they maintain a uniform gap.

In order to make the cell gap, the spacers are usually dispersed on one of the substrates before they are assembled. Then, the substrates are sealed with a sealant, and a liquid crystal material is injected into the gap between the substrates.

Unfortunately, the alignment of the liquid crystal molecules near the spacers become disordered. In other words, the liquid crystal molecules become randomly arranged near the spacers, but are uniformly arranged in other regions. As a result, the light leakage occurs near the spacers, thereby reducing the contrast ratio.

In particular, the LCD in normally black mode may not obtain sufficient black state due to the light leakage near the spacers, and thus the contrast ratio may be reduced.

### SUMMARY OF THE INVENTION

It is an object of the present invention to reduce light leakage in the LCD.

It is another object of the present invention to increase the contrast ratio in the LCD.

These and other objects, features and advantages are provided, according to the present invention, by using spacers which align nearby liquid crystal molecules so that they are parallel to the surface of the spacers.

The LCD includes a first panel having two kinds of electrodes that are separated from each other and generate electric field by applying voltage. A second panel is spaced apart from the first panel. A liquid crystal layer is interposed between the first and the second panels and a plurality of spacers are dispersed in the liquid crystal layer. In the liquid display layer, the spacers align liquid crystal molecules near the spacers in a substantially regular manner.

### BRIEF DESCRIPTION OF THE DRAWINGS

FIG. 1 is a cross-sectional view of an LCD according to one embodiment of the present invention.

FIGS. 2 and 3 are plan views showing the alignment of the liquid crystal molecules near spacers according to two embodiments of the present invention.

### DETAILED DESCRIPTION OF THE PREFERRED EMBODIMENTS

The present invention will now be described more fully with reference to the accompanying drawings, in which preferred embodiments of the present invention are shown. In the drawings, the thickness of layers and regions are exaggerated for clarity.

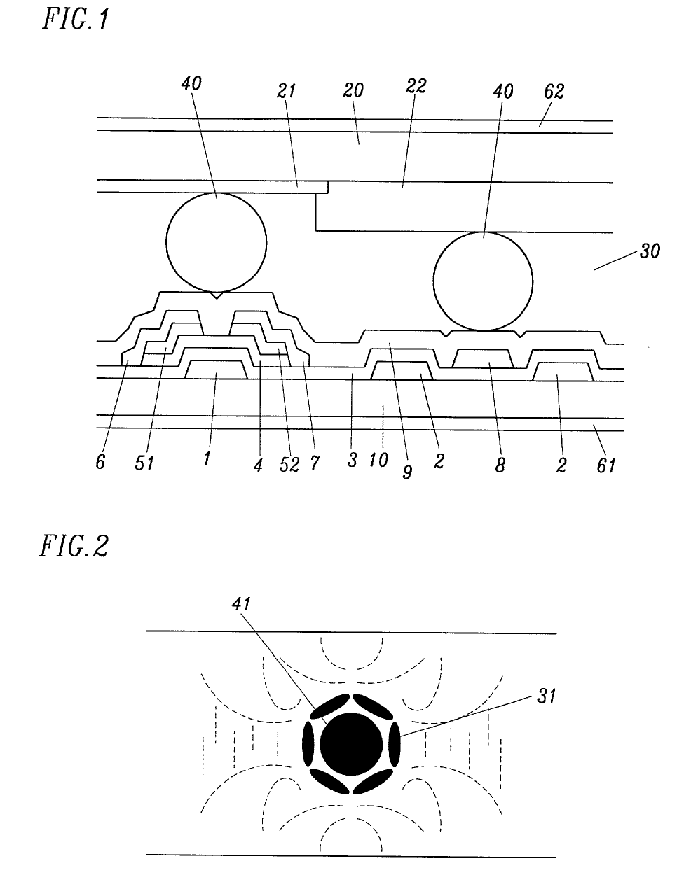

FIG. 1 is a cross-sectional view of a LCD according to an embodiment of the present invention.

As shown in FIG. 1, two insulating substrates 10 and 20 are spaced apart from each other. A liquid crystal layer 30 is interposed between the substrates 10 and 20, and a plurality of spacers 40 maintaining a suitable cell gap are dispersed in the liquid crystal layer 30. A pair of polarizers, a polarizer 61 and an analyzer 62, are attached to the outer surfaces of the substrate 10 and substrate 20 respectively. The polarizing directions of the polarizer 61 and the analyzer 62 are perpendicular to each other.

Formed on the lower substrate 10 are a gate electrode 1 applied with a scanning signal. Common signals are applied to common electrodes 2. A gate insulating layer 3 is formed on the gate electrode 1 and the common electrodes 2. A semiconductor layer 4 of a material such as intrinsic amorphous silicon is formed on the gate insulating layer 3 opposite the gate electrode 1. An ohmic contact layer 51 and 52 of doped amorphous silicon is formed on the semiconductor layer 4 and includes two separate portions 51 and 52 opposite to each other with respect to the gate electrode 1. A source electrode 6 and a drain electrode 7 are formed on the respective portions 51 and 52 of the ohmic contact layer. A pixel electrode 8 to which a display signal is applied, is formed on the gate insulating layer 3. The pixel electrode 8 and the common electrodes 2 are located in a pixel region and alternately arranged to generate an electric field. Though not shown in the figures, the drain electrode 7 is electrically connected to the pixel electrode 8. The gate electrode 1, the gate insulating layer 3, the semiconductor layer 4, the ohmic contact layer 51 and 52, the source electrode 6 and the drain electrode 7 form a thin film transistor (TFT) that receives a display signal via the source electrode 6 and transmits the display signal to the pixel electrode 8 via the drain electrode 7. Finally, a passivation layer 9 covers the TFT and the pixel electrode 8, and an alignment film (not shown) is formed on the passivation layer 9.

Formed on the upper substrate 20 are a black matrix 21 located at the position corresponding to the TFT of the lower substrate 10 and a color filter 22 located at the position corresponding to the pixel region. An alignment layer (not shown) is formed on the black matrix 21 and the color filter 22.

Now, the operation of the LCD is described.

In the absence of an electric field, the long axes of most liquid crystal molecules in the liquid crystal layer 30 are arranged in a fixed direction either substantially parallel or substantially perpendicular to the substrates 10 and 20. The incident light polarized by the polarizer 61 passes through the liquid crystal layer 30 without changing its polarization. Then, the light is blocked by the analyzer 62 to make a black state.

When an electric field is generated by applying signal voltages to the common electrode 2 and the pixel electrode 8, the liquid crystal molecules align themselves such that their long axes are either parallel or perpendicular to the field direction, while the liquid crystal molecules remain in their initial states along the alignment layer. Accordingly, the liquid crystal molecules are rearranged as follows: the liquid crystal molecules near the central region between the substrates 10 and 20, which is far from the surfaces of the substrates 10 and 20, are either substantially parallel or substantially perpendicular to the field direction, and those near the surfaces of the substrates 10 and 20 stay in their initial states. As a result, the director of the liquid crystal layer 30 twists spirally from one substrate to the midposition between the substrates, and the incident light polarized by the polarizer 61 changes its polarization when passing through the liquid crystal layer 30. Therefore, the light, at least in part, passes through the analyzer 62 to make a white state.

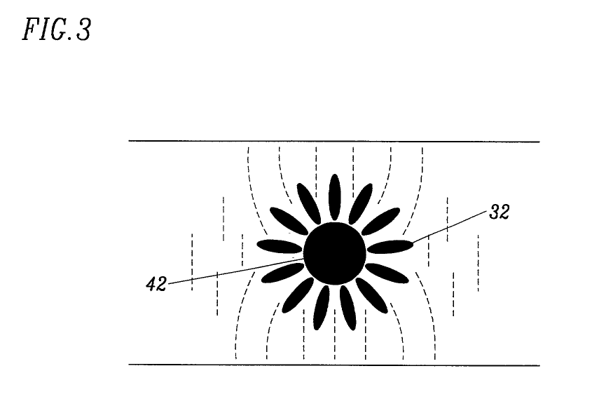

FIGS. 2 and 3 are plan views showing the alignment of the liquid crystal molecules near the spacers according to two embodiments of the present invention. The spacers shown in FIG. 2 and FIG. 3 are homogeneously aligning spacers and homeotropically aligning spacers, respectively.

As shown in FIGS. 2 and 3, liquid crystal molecules 31 and 32 near spacers 41 and 42 are aligned homogeneously (FIG. 2) and homeotropically (FIG. 3) to the surfaces of the spacers 41 and 42, respectively. Then, the liquid crystal molecules 31 and 32 are arranged in a regular manner with respect to the surfaces of the spacers 41 and 42. The dotted lines represent the tangential lines of the long axes of the liquid crystal molecules.

When the homeotropically aligning spacer 42 is used as shown in FIG. 3, the size of the region where the arrangement of the liquid crystal molecules is changed due to the influence of the spacer 42 is very small compared with when using the homogeneously aligning spacer 41. It is because the aligning force of the homeotropically aligning spacer 42 is smaller than that of the homogeneously aligning spacer 43. Therefore, the light leakage due to the disordered arrangement of the liquid crystal molecules is reduced dramatically when using the homeotropically aligning spacer 42.

Test panels were made using the spacers according to the present invention, and the luminance in the black state was measured. Then the contrast ratio CR for the LCD operating in normally black mode was calculated by the following equation:

CR=(luminance)_{ON}/(luminance)_{OFF},

where (luminance)_{ON} represents the luminance when a voltage is applied and (luminance)_{OFF} represents the luminance when the voltage is not applied (off state).

In this test, the size of the test panels was 15.1 inches. A bear glass panel without TFTs and wires and a color filter panel having complete elements such as color filters and a black matrix was used. Spacers of 2 g and solution of 200 ml including IPA (isopropyl alcohol) of 80 ml, Me—OH of 20 ml and DI (de-ionized) water of 100 ml were mixed and sprayed on one of the panels using the conventional dispersing method. The spacers used in this test were “LUNAPEARL” which are manufactured by KAO, a Japanese company using a seed polymerization method, and are a copolymer including di-vinyl benzene as a primary component. The aligning tendency of the spacers is dependent on the amount of hydrophilic and hydrophobic components of the copolymer, and becomes homeotropic as the amount of the hydrophobic components increases. The number of the spacers per unit area was 120/mm².

According to the test result, the luminance in the black state decreased, and the uniformity of luminance in black state increased considerably. The contrast ratio of the LCD using the conventional spacers was 169, while that for the homogeneously aligning spacers was 250, thereby realizing 47.4% increase in the contrast ratio. When using the homeotropically aligning spacers, the contrast ratio is 289, which indicates 70.0% increase compared with the conventional case. As described above, the uniformity of the luminance is increased, which is believed to be caused by the present spacer's superior capability of absorbing and discharging electrostatic charges. Since the homogeneously or the homeotropically aligning spacers has a high absorption rate for ionic impurities, the amount of the electrostatic charges and thus the strength of the electric field generated by the electrostatic charges are reduced. Accordingly, the homogeneously and the homeotropically aligning spacers decrease the light leakage and the afterimage by reducing electrostatic charges.

In addition, the voltage maintaining capability of the LCD was not reduced.

According to present invention, the homogeneous or the homeotropic alignment spacers are used for the display where two field generating electrodes formed on one substrate. However, the spacers may be used in other types of LCDs, for example, twisted nematic LCD or vertically aligned twisted nematic LCD. The spacers according to the present invention are particularly useful for the LCD where the liquid crystal molecules are aligned in parallel to the substrates and operates in a normally black mode.

In the drawings and specification, there have been disclosed preferred embodiments of the invention and, although specific terms are employed, they are used in a generic and descriptive sense only and not for purposes of limitation, the scope of the invention being set forth in the following claims.

What is claimed is:

1. A liquid crystal display comprising:
a first and a second panels spaced apart from each other and having a first and a second electrode, respectively, separated from each other which generate electric field by applying voltage;
a liquid crystal layer interposed between the first and the second panels; and
a plurality of spacers dispersed in the liquid crystal layer,
wherein the spacers align liquid crystal molecules near the spacers in a substantially regular manner with respect to surfaces of the spacers.

2. The liquid crystal display of claim 1, wherein long axes of the liquid crystal molecules are aligned substantially parallel to the first and second panels.

3. The liquid crystal display of claim 2, further comprising a pair of polarizers attached to the outer surfaces of the first and the second panels, wherein polarizing directions of the polarizers are substantially perpendicular to each other.

4. The liquid crystal display of claim 3, wherein the spacers align the liquid crystal molecules near the spacers substantially parallel to surfaces of the spacers.

5. The liquid crystal display of claim 3, wherein the spacers align the liquid crystal molecules near the spacers substantially perpendicular to the surfaces of the spacers.

6. The liquid crystal display of claim 3, wherein some of the spacers align the liquid crystal molecules near the spacers substantially parallel to the surfaces of the spacers, and the remaining spacers align the liquid crystal molecules near the spacers substantially perpendicular to the surfaces of the spacers.

7. The liquid crystal display of claim 1, wherein the first panel has both the first and the second electrodes.
